(19) United States
(12) Patent Application Publication
(10) Pub. No.: US 2022/0188583 A1
(43) Pub. Date: Jun. 16, 2022

(54) LARGE-SCALE POLICY EVALUATION IN MULTI-AGENT SYSTEMS

(71) Applicant: Huawei Technologies Co., Ltd., Shenzhen (CN)

(72) Inventors: Yaodong YANG, Shenzhen (CN); Rasul TUTUNOV, London (GB); Phu SAKULWONGTANA, Munich (DE); Haitham BOU AMMAR, London (GB); Jun WANG, London (GB)

(21) Appl. No.: 17/686,113

(22) Filed: Mar. 3, 2022

Related U.S. Application Data
(63) Continuation of application No. PCT/EP2019/073406, filed on Sep. 3, 2019.

(51) Int. Cl. G06K 9/62

(52) U.S. Cl. CPC G06K 9/6293; G06K 9/6265; G06K 9/623; G06K 9/6263

(57) ABSTRACT

A computer-implemented policy evaluation system for identifying an optimal combination of operational policies for implementation by a plurality of actors, each actor being capable of adopting any of a plurality of operational policies, the policy evaluation system being configured to iteratively perform the following steps: (i) selecting a first combination of operational policies, the first combination defining a policy for each actor; (ii) receiving vectors of values, each representing the benefit of a respective second combination where all but one of the actors adopts the policy defined for it in the first combination and that actor adopts a different policy; and (iii) estimating a ranking of combinations of policies for the actors in dependence on those values and a previously estimated ranking of combinations of policies for the actors.

### CROSS-REFERENCE TO RELATED APPLICATIONS

This application is a continuation of International Application No. PCT/EP2019/073406, filed on Sep. 3, 2019, the disclosure of which is hereby incorporated by reference in its entirety.

### FIELD OF THE INVENTION

Embodiments of this invention relate to multi-agent systems, in particular to policy evaluation in such systems.

### BACKGROUND

Many real-world applications involve multi-agent system modelling, ranging from selecting the strongest artificial intelligence robot to play video games against humans, to developing a population of safe self-driving cars that will never collide with one another.

These tasks usually involve different types of interactions among the multiple agents involved. With multi-agent learning techniques becoming increasingly complicated, how to efficiently evaluate the effectiveness of each individual agent's policy, or the joint policy as a whole, in such multi-agent environments becomes a critical problem.

ELO Rating, as described in Arpad E. Elo, ‘The rating of chess players, past and present’, Arco Pub., 1978, is a common approach to policy evaluation that is widely used in ranking players in competitive games including football, chess and Go. Players with a higher ELO rating have a higher probability of winning a game than players with a lower ELO rating. If a player with a higher ELO rating wins, only a few points are transferred from the lower rated player, whereas if a lower rated player wins, then the number of transferred points from a higher rated player is far greater. However, a disadvantage of the ELO rating method is that it cannot deal with intransitive behaviours in the game. For example, the cyclical best-responses in a game of Rock-Paper-Scissors. Also, in this game, a Rock-playing agent will attain a high ELO score if more Scissor-playing agents are introduced into a tournament, while the ground truth should be that Rock, Paper and Scissors are equally likely, regardless of how many times Rock is played.

Computing the Nash equilibrium, as described in David Balduzzi, Karl Tuyls, Julien Perolat, and Thore Graepel, ‘Re-evaluating evaluation’, Advances in Neural Information Processing Systems, pages 3268-3279, 2018, and John F. Nash et al., ‘Equilibrium points in n-person games’, Proceedings of the National Academy of Sciences, 36(1), 48-49, 1950, is a classical solution concept in Game Theory for strategy evaluations. However, targeting at Nash equilibrium is problematic in many ways. For example, it is not guaranteed that any dynamical game can converge to a Nash equilibrium. It is also known that solving for a Nash equilibrium in general-sum games is Polynomial Parity Arguments on Directed graphs (PPAD)—complete, which seriously limits the complexity of the multi-agent system that can be evaluated. It is also unclear how to select the equilibrium among the many Nash equilibria of a game.

Replicator dynamics from Evolutionary Game Theory, as described in Peter Schuster and Karl Sigmund, ‘Replicator dynamics’, Journal of Theoretical Biology, 100(3): 533-538, 1983, are often deployed to capture the micro-dynamics of interacting agents in the multi-agent system. These approaches focus on studying the basins of attraction and equilibria of the evaluating agents' strategies. However, they are limited, as they can only be feasibly applied to games involving few agents. Furthermore, this approach cannot deal with games with asymmetric payoff.

Alpha-Rank, as described in Shayegan Omidshafiei, Christos Papadimitriou, Georgios Piliouras, Karl Tuyls, Mark Rowland, Jean-Baptiste Lespiau, Wojciech M Czarnecki, Marc Lanctot, Julien Perolat, and Remi Munos, ‘Alpha-Rank: Multi-agent evaluation by evolution’, Nature: Scientific Report, 2019, enables an evolutionary analysis of multi-agent interactions for asymmetric games by introducing Markov-Conley Chains. However, this approach runs in polynomial time and space with respect to the total number of pure strategy profiles, which prohibits its usage for real-world applications. When designing a self-driving car solution for a community of ten cars, each car having only two strategies to choose from, the time complexity to find the best joint strategy using Alpha-Rank would be [symbol] =(2³⁰), which is intolerable. This method therefore cannot be scaled to tackle multi-agent problem with large population size.

It is desirable to model the inherently dynamical behaviors of a multi-agent policy evaluation problem, in both simulation engines and the real-world environment, in a way that can be scaled up to tackle large-scale policy evaluation problems.

### SUMMARY OF THE INVENTION

According to one aspect there is provided a computer-implemented policy evaluation system for identifying an optimal combination of operational policies for implementation by a plurality of policy-driven actors, each actor being capable of adopting any of a plurality of operational policies, the policy evaluation system being configured to iteratively perform the following steps: (i) selecting a first combination of operational policies, the first combination defining a policy for each actor; (ii) receiving vectors of values, each representing the benefit of a respective second combination where all but one of the actors adopts the policy defined for it in the first combination and that actor adopts a different policy; and (iii) estimating a ranking of combinations of policies for the actors in dependence on those values and a previously estimated ranking of combinations of policies for the actors.

The said set of values may be a row or column of the transition matrix of the joint-policy profile for all the actors. This can permit the system to iteratively converge on a ranking of all possible combinations of the policies that is optimum to within a predetermined threshold, with no need to list all those possible combinations.

The iteratively performed steps may comprise: (iv) assessing whether the ranking of combinations of policies for the actors has converged to a predetermined degree; and if that assessment is positive, assigning to each of the actors the policy defined for it in the highest-ranked combination in the ranking. Once the system has iteratively converged on an adequate solution that solution can advantageously be adopted by each actor implementing the respective policy as indicated for it in the highest ranked combination of the solution.

The step of estimating the ranking of combinations of policies for the actors may comprise estimating an adjustment from the previously estimated ranking of combinations of policies for the actors and applying that adjustment to the previously estimated ranking of combinations of policies for the actors. This can assist the system in reaching the eventual solution in an iterative way, potentially improving efficiency.

The system may be configured to compute each of the said values as:

$$\{ \begin{matrix}\frac{1}{{\sum }_{k = 1}^{N} ( \vert {S}_{k} \vert - 1 )} {ρ}_{{s}_{i}^{k} , {s}_{j}^{k}}^{k} ( {s}_{i}^{- k} ) & if ∃ k \text{:} {s}_{i}^{k} \neq {s}_{j}^{k} \& {s}_{i}^{- k} = {s}_{j}^{- k} \\ 1 - {\sum }_{j \neq i} {c}_{ij} & if {s}_{i} = {s}_{j} \\ 0 & otherwise\end{matrix} \\ where \text{:} \\ {ρ}_{{s}_{i}^{k} , {s}_{j}^{k}}^{k} ( {s}_{i}^{- k} ) = \{ \begin{matrix}\frac{1 - {e}^{- α ( {M}^{( k )} ( {s}_{j}^{k} , {s}_{i}^{- k} ) - {M}^{( k )} ( {s}_{i}^{k} , {s}_{i}^{- k} ) )}}{1 - {e}^{- m α ( {M}^{( k )} ( {s}_{j}^{k} , {s}_{i}^{- k} ) - {M}^{( k )} ( {s}_{i}^{k} , {s}_{i}^{- k} ) )}} & if {M}^{( k )} ( {s}_{j}^{k} , {s}_{i}^{- k} ) \neq {M}^{( k )} ( {s}_{i}^{k} , {s}_{i}^{- k} ) \\ \frac{1}{m} & otherwise\end{matrix}$$

and:
α is a ranking intensity
k is an index of the first agent
M^{(k)}(sᵢ^{k},sᵢ^{-k}) is the fitness/reward for agent k using policy sᵢ^{k} while the other agents use policy sᵢ^{-k}
m is a hyper-parameter representing the population size
Sₖ is the k-th joint combination.

The system may be configured to estimate the ranking of combinations of policies for the actors as:

$$Sample {i}_{t} ∼ [ 1 , … , n ] and {∇}_{x} {f}_{rel , i} = 2 ( {b}_{{i}_{t}}^{T} x ) {b}_{{i}_{t}} - \frac{{α}_{i} 1}{{x}_{i}^{r} 1 - 1 + {ϵ}_{1}} + \frac{{α}_{i} 1}{1 + {ϵ}_{t} - {x}_{i}^{r} 1} . \\ Update {x}_{t + 1} = {x}_{t} - {η}_{t} {∇}_{x} {f}_{rel , i} .$$

where:
b is the said vector of values
l is a vector full of ones
x is a rank to be output
eta is a learning rate
epsilon is an accuracy parameter

The system may be configured to store the said set of values in a compressed form in which are specified: (i) the quantity of the most common one of the said values and (ii) the index and quantity of each of the said values that is not equal to the most common one of the said values. This can reduce memory consumption.

The quantity of each of the said values that is not equal to the most common one of the said values may be specified as a difference between that quantity and the quantity of the most common one of the said values. This can reduce memory consumption.

In each iteration it may be that the only values in dependence on which the preferred combination of policies for the actors is estimated are the sets of values each representing a benefit of a respective second combination where all but one of the actors adopts the policy defined for it in the first combination and that actor adopts a different policy. This can simplify the computation process.

In each iteration it may be that the only values in dependence on which the preferred combination of policies for the actors is estimated is the values of the respective row or column of the transition matrix of the joint policy profile for the actors. This can simplify the computation process.

The actors may be policy-driven actors. The actors may be at least partially autonomous vehicles and the policies may be driving policies. M may indicate a representation of the fitness for a combination of joint driving policies. The actors may be capable of interacting with each other in implementing the policies. In this way, the highest ranked combination can result in relatively efficient operation of the actors as a group.

The step of selecting an actor may be performed stochastically. This can allow for an optimal combination to be found efficiently.

According to a second aspect there is provided a computer-implemented method for identifying an optimal combination of operational policies for implementation by a plurality of actors, each actor being capable of adopting any of a plurality of operational policies, the method comprising iteratively performing the following steps: (i) selecting a first combination of operational policies, the first combination defining a policy for each actor; (ii) receiving vectors of values, each representing the benefit of a respective second combination where all but one of the actors adopts the policy defined for it in the first combination and that actor adopts a different policy; and (iii) estimating a ranking of combinations of policies for the actors in dependence on those values and a previously estimated ranking of combinations of policies for the actors.

According to a third aspect there is provided a data carrier storing in non-transient form a set of instructions for causing a computer to perform the method set out in the preceding paragraph.

### BRIEF DESCRIPTION OF THE FIGURES

The present invention will now be described by way of example with reference to the accompanying drawings.

In the drawings:

FIG. 1 shows a summary for determining the ranking for joint strategies compared to traditional approaches, in accordance with embodiments of the disclosure.

FIG. 2 shows a stochastic optimization routine (Algorithm 1), in accordance with embodiments of the disclosure.

FIG. 3 shows an example of an algorithm which summarizes evolutionary policy evaluation (Algorithm 2), in accordance with embodiments of the disclosure.

FIG. 4 shows an example of a computer-implemented method for identifying an optimal combination of operational policies for implementation by a plurality of actors, in accordance with embodiments of the disclosure.

FIGS. 5 to 8 show an exemplary flow diagram illustrating the application of the method described herein, in accordance with embodiments of the disclosure.

FIG. 9 shows a more detailed summary of the steps that are performed to compute the fixtate probability indicated at 701 in FIGS. 7 and 801 in FIG. 8 based on the start joint strategy profiles and the end joint strategy profiles.

FIG. 10 summarises the steps that are performed generally when a simulator is run, in accordance with embodiments of the disclosure.

FIG. 11 illustrates a data structure for storing the sparse vector that leverages the sparse property of the transitional probability matrix C, in accordance with embodiments of the disclosure.

FIG. 12 shows a comparison of the time and space complexity for the example of a population of self-driving cars, where N=number of cars, K=number of strategies per car, [symbol] =precision, in accordance with embodiments of the disclosure.

FIG. 13 shows the results of comparative experiments for time complexity, in accordance with embodiments of the disclosure.

FIG. 14 shows the results of comparative experiments for space complexity, in accordance with embodiments of the disclosure.

FIG. 15 shows an example of a policy evaluation system, in accordance with embodiments of the disclosure.

### DETAILED DESCRIPTION OF THE INVENTION

Embodiments of the present invention concern an evolution-principled method to evaluate and rank agents' policies in a large-scale multi-agent setting. The method produces a ranking over agents' joint policies that are favoured by the evolutionary dynamics by filtering out transient strategies that will go extinct in the long-term evolutionary interactions.

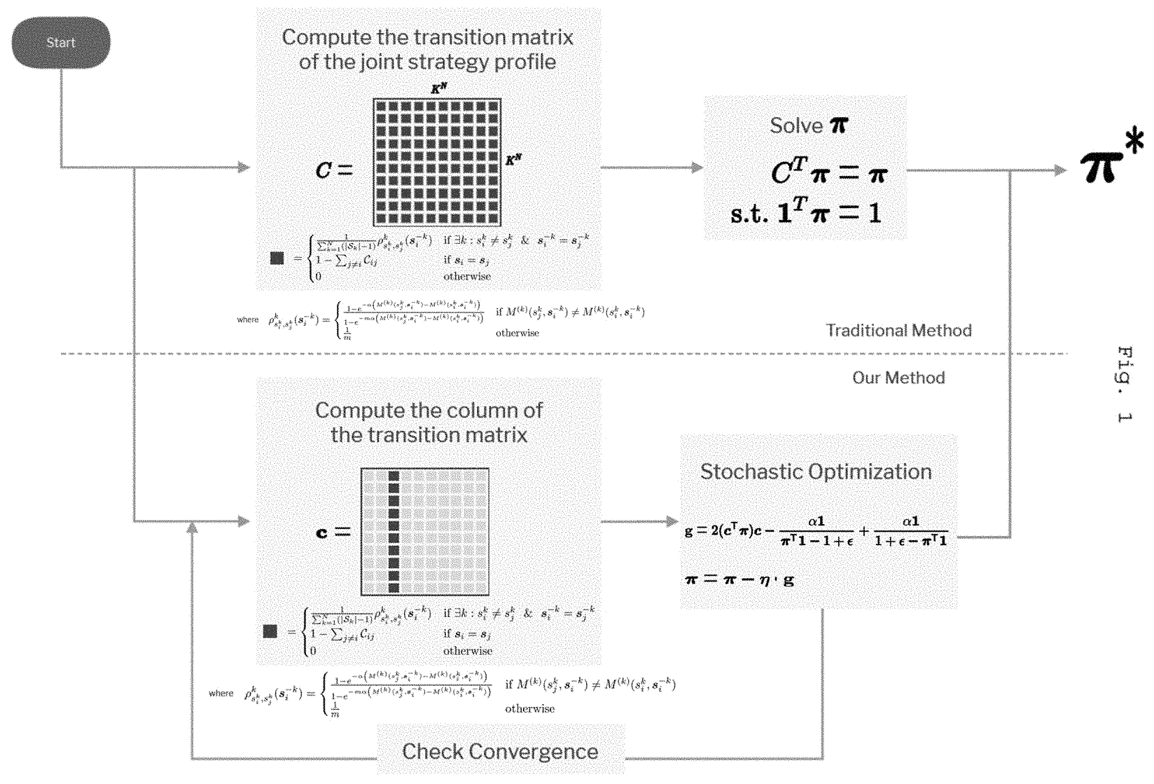

FIG. 1 shows a summary of the present approach, shown generally at 101, compared to traditional approaches, shown generally at 102. The present approach and its differences over traditional approaches will now be described.

It is assumed that there is a community of agents [symbol] ={1, . . . , N} and each agent i has a collection of strategies/policies S⁽ⁱ⁾={sᵢ₁, . . . , s_{iK}_{ᵢ}} it can apply. For example, in the case of a self-driving car, each driving strategy can be treated as a policy, defining an agent's action on the road.

Without losing generality, it is assumed that the total number of driving strategies Kᵢ can vary for different agents. It is assumed that they are the same for easy notation Kᵢ=Kⱼ, (i, j∈{1, . . . , N}).

Each agent has a payoff function M⁽ⁱ⁾: Πᵢ₌₁^{N}Sᵢ→ [symbol] ⁺. In other words, the payoff function of each agent i depends not only on the chosen strategy for agent i but also on the strategies of all other agents.

Assuming that each agent i chooses a strategy s_{iq}∈Sᵢ then let us denote

$$s = ( {s}_{{1}_{q 1}} , {s}_{{2}_{q 2}} , … , {S}_{{N}_{{q}_{N}}} )$$

as the joint strategy profile, and the corresponding pa-offs by

$$M ( s ) = ( {M}^{( 1 )} ( {s}_{{1}_{q 1}} , {s}^{- 1} ) , {M}^{( 2 )} ( {s}_{{2}_{q 2}} , {s}^{- 2} ) , … , {M}^{( N )} ( {s}_{{N}_{qN}} , {s}^{- N} ) ) ,$$

where s⁻¹=(s_{iq}_{ᵢ}, s_{i-1q}_{_{i−1}}, s_{i+1q}_{ᵢ₊₁}, . . . , s_{N}_{_{qN}}) is the strategy profile of all agents except agent i.

The goal is to provide a ranking algorithm that can offer the rankings over the set of all possible joint strategy profiles under evaluation and provide insights into these strategies, including their strengths, weakness, and the dynamics of survival in the sense of evolution.

For each agent i, a population [symbol] is created comprising m copies of agent i. The game of policy evaluation can essentially be represented as a Markov Chain, where the state space is given as a collection of all joint strategy profiles, i.e. S_{MC}=Πᵢ₌₁^{N}Sᵢ→ [symbol] ⁺ and the transitional probability matrix C∈ [symbol] ^{|S}^{_{MC}}^{|×|S}^{_{MC}}^{|} is defined as follows for any sᵢ, sⱼ∈S_{MC}:

$$\begin{matrix}{𝒞}_{ij} = \{ \begin{matrix}\frac{1}{{\sum }_{k = 1}^{N} ( \vert {𝒮}_{k} \vert - 1 )} {ρ}_{{s}_{i}^{k} , {s}_{j}^{k}}^{k} ( {s}_{i}^{- k} ) & if ∃ k \text{:} {s}_{i}^{k} \neq {s}_{j}^{k} \& {s}_{i}^{- k} = {s}_{j}^{- k} \\ 1 - {\sum }_{j \neq i} {𝒞}_{ij} & if {s}_{i} = {s}_{j} \\ 0 & otherwise\end{matrix} \\ where \text{:} & ( 1 ) \\ {ρ}_{{s}_{i}^{k} , {s}_{j}^{k}}^{k} ( {s}_{i}^{- k} ) = \{ \begin{matrix}\frac{1 - {e}^{- α ( {M}^{( k )} ( {s}_{j}^{k} , {s}_{i}^{- k} ) - {M}^{( k )} ( {s}_{i}^{k} , {s}_{i}^{- k} ) )}}{1 - {e}^{- m α ( {M}^{( k )} ( {s}_{j}^{k} , {s}_{i}^{- k} ) - {M}^{( k )} ( {s}_{i}^{k} , {s}_{i}^{- k} ) )}} & if {M}^{( k )} ( {s}_{j}^{k} , {s}_{i}^{- k} ) \neq {M}^{( k )} ( {s}_{i}^{k} , {s}_{i}^{- k} ) \\ \frac{1}{m} & otherwise\end{matrix} & ( 2 )\end{matrix}$$

M^{(k)}(sᵢ^{k},sᵢ^{-k}) is the fitness/reward for agent k playing strategy sᵢ^{k} while the other agents play sᵢ^{-k}. In Equation (2), a is defined to be the ranking intensity, the hyper parameters of the algorithm.

The constructed Markov Chain is irreducible and ergodic, hence there exists a limit distribution over the set of joint strategy profiles π∈ [symbol] ₊^{|S}^{_{MC}}^{|}:

$$v = {lim}_{t \to ∞} {v}_{0} {C}^{t} \qquad ( 3 )$$

which does not depend on the initial distribution v₀. v is also a stationary distribution.

The stationary distribution v for each agent shows how much time, on average, the Markov Chain spends in the corresponding state. Hence, in order to pick the most preferable joint strategy profiles, s* is defined such that:

$${s}^{*} = arg {max}_{s ∈ {S}_{M C}} v ( s ) \qquad ( 4 )$$

Moreover, the stationary distribution π allows for the ranking of each individual strategy s_{iq} for each agent i as follows. For each strategy s_{iq}∈Sᵢ the value of the following is computed:

rank(s_{iq})=Σₛ−i v(s_{iq},s⁻ⁱ) (5)

Based on this value, all of the strategies s_{iq}∈Sᵢ for agent i can be sorted. Computing the corresponding stationary distribution v of the transition probability matrix C can be cast as convex constrained optimisation problem:

$${min}_{x} \frac{1}{n} {‖ {𝒞}^{⊤} x - x ‖}_{2}^{2} \\ s . t . x ≽ 0 \& {x}^{⊤} 1 = 1. \\ where n = \vert {S}_{MC} \vert = {\prod }_{i = 1}^{N} {K}_{i} . \qquad ( 6 )$$

As illustrated generally in FIG. 1 at 102, traditional methods need to pre-compute and store the whole transition matrix, which could be prohibitively large. As will now be described, shown generally at 101 in FIG. 1, by adopting a stochastic optimization method with an augmented Lagrangian to compute the stationary distribution, only one column (or row) of the transition matrix is accessed at each iteration, and the number of iterations needed are also much less than traditional linear algebra methods or power methods. Specifically, the above problem is reformulated as a non-constrained one:

$${min}_{x} \underbrace{\frac{1}{n} {‖ {𝒞}^{⊤} x - x ‖}_{2}^{2} - α ( log ( {x}^{⊤} 1 - 1 + ϵ ) + log ( 1 + ϵ - {x}^{⊤} 1 ) )}_{{f}_{rel} ( x , α , t )} \qquad ( 7 )$$

where the following relaxation of the equality constrained condition is utilised:

x^{T}1−1+∈≥0&1+∈−x^{T}1≥0 (8)

for some accuracy parameter ∈>0. In Equation (7), α is a weighting parameter.

Iterative updates are then performed. During the iterative updates, both parameters ∈ and α are gradually reduced.

The above problem can be further cast as a finite sum minimization problem. Let bᵢ denote the i^{th} row of matrix C^{T}−I, then:

$${f}_{rel} ( x , α , ϵ ) = \frac{1}{n} {\sum }_{i - 1}^{n} {( {b}_{i}^{⊤} x )}^{2} - α ( log ( {x}^{⊤} 1 - 1 + ϵ ) + log ( 1 + ϵ - {x}^{⊤} 1 ) ) = \frac{1}{n} {\sum }_{i - 1}^{n} [ \underbrace{{( {b}_{i}^{⊤} x )}^{2} - α ( log ( {x}^{⊤} 1 - 1 + ϵ ) + log ( 1 + ϵ - {x}^{⊤} 1 ) )}_{{f}_{rel , i} ( x , α , ϵ )} ] = \frac{1}{n} {\sum }_{i = 1}^{n} {f}_{rel , i} ( x , α , ϵ ) \qquad ( 9 )$$

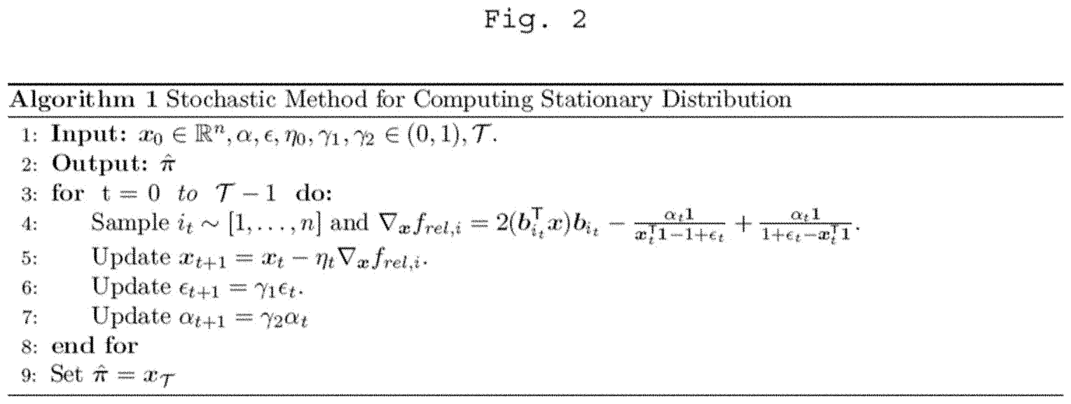

As shown at 103 in FIG. 1, a stochastic optimization routine is adopted as the iterative method for solving the above optimization problem. This process is summarised by Algorithm 1, shown in FIG. 2.

Therefore, a first combination of policies is selected, the first combination defining a policy for each actor (for example, each car in the population of self-driving cars). A vector of values is received, each representing the benefit of a respective second combination of operational policies where all but one of the actors adopts the policy defined for it in the first combination and that actor adopts a different policy. A ranking of combinations of policies for the actors is estimated in dependence on those values and a previously estimated ranking of combinations of policies for the actors. The ranking is iteratively updated by estimating an adjustment from the previously estimated ranking of combinations of policies and that adjustment is applied to the previously estimated ranking of combinations of policies.

Whereas in previous approaches, the whole of the transitional matrix needs to be pre-computed and stored, in present approach, the said set of values is a row or column of the transition matrix of the joint-policy profile, i.e. only one row or column of the matrix is required in each iteration.

In a preferred implementation, in each iteration, the only values in dependence on which the preferred combination of policies for the actors is estimated are the sets of values each representing a benefit of a respective second combination where all but one of the actors adopts the policy defined for it in the first combination and that actor adopts a different policy. Therefore, the algorithm may select all possible joint strategy profiles that differ by one agent. The outcome of the method is the optimal stationary distribution re, i.e. the preferred ranking for the joint strategies, as illustrated generally at 104 in FIG. 1.

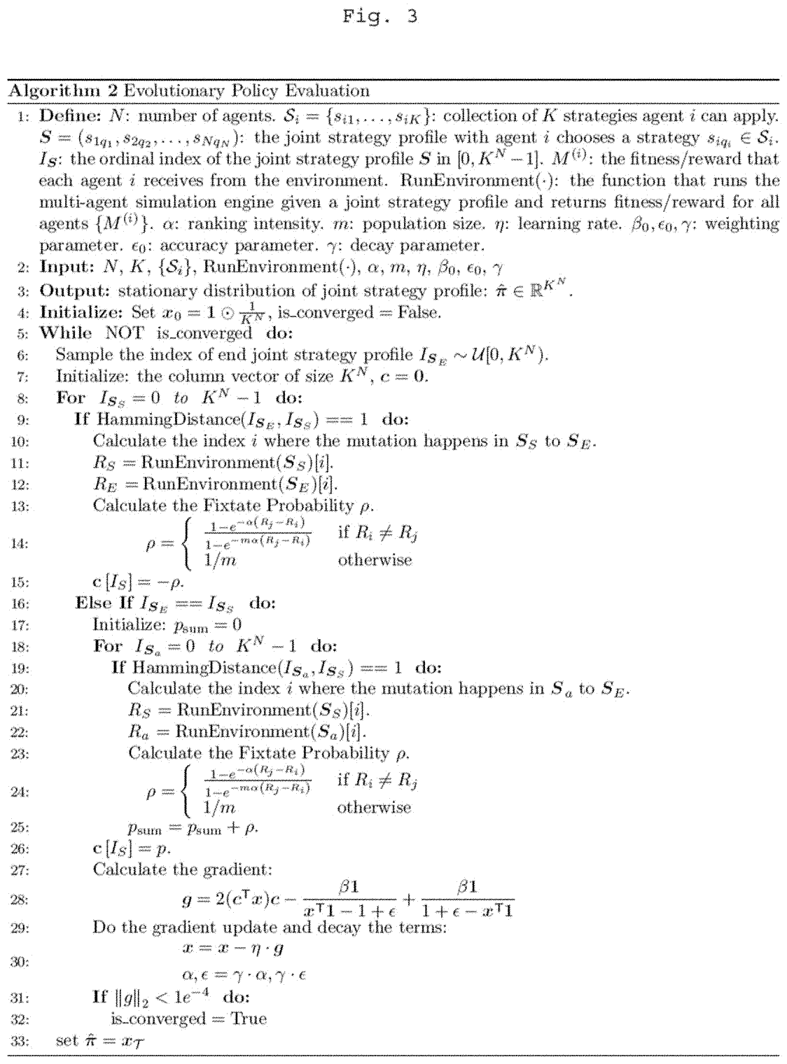

The whole evolutionary policy evaluation approach is summarised by Algorithm 2, shown in FIG. 3.

Each agent's policy may be augmented and learned during the game, rather than being fixed at the beginning of the game. The whole transitional matrix does not need to be pre-computed and stored. The method can use a row or column of the transition matrix in each iteration. This can permit the system to iteratively converge on an optimum ranking of possible combinations of the policies.

When it is detected that the ranking of combinations of policies for the actors has converged to a predetermined degree, i.e. π=π*, each of the actors ca be assigned the policy defined for it in the highest-ranked combination in the ranking.

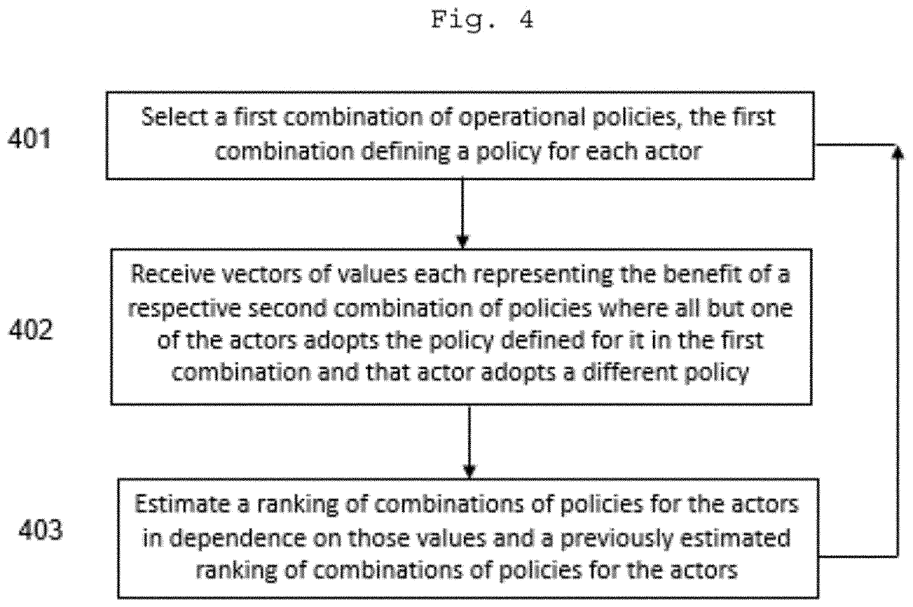

FIG. 4 summarises a computer-implemented method for identifying an optimal combination of operational policies for implementation by a plurality of actors, each actor being capable of adopting any of a plurality of operational policies. The method comprising iteratively performing the following steps. At step, 401 the method comprises selecting a first combination of operational policies, the first combination defining a policy for each actor. At step 402, the method comprises receiving vectors of values each representing the benefit of a respective second combination of policies where all but one of the actors adopts the policy defined for it in the first combination and that actor adopts a different policy At step 403, the method comprises estimating a ranking of combinations of policies for the actors in dependence on those values and a previously estimated ranking of combinations of policies for the actors.

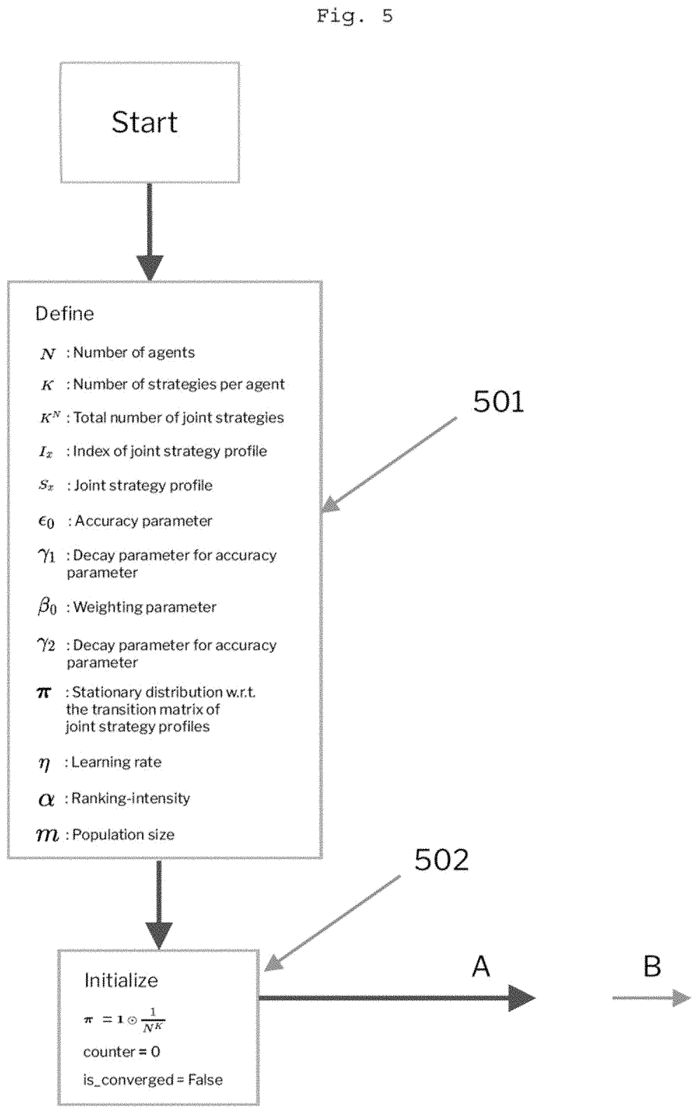

A detailed system diagram of how the proposed method may be applied is shown in FIGS. 5 to 8.

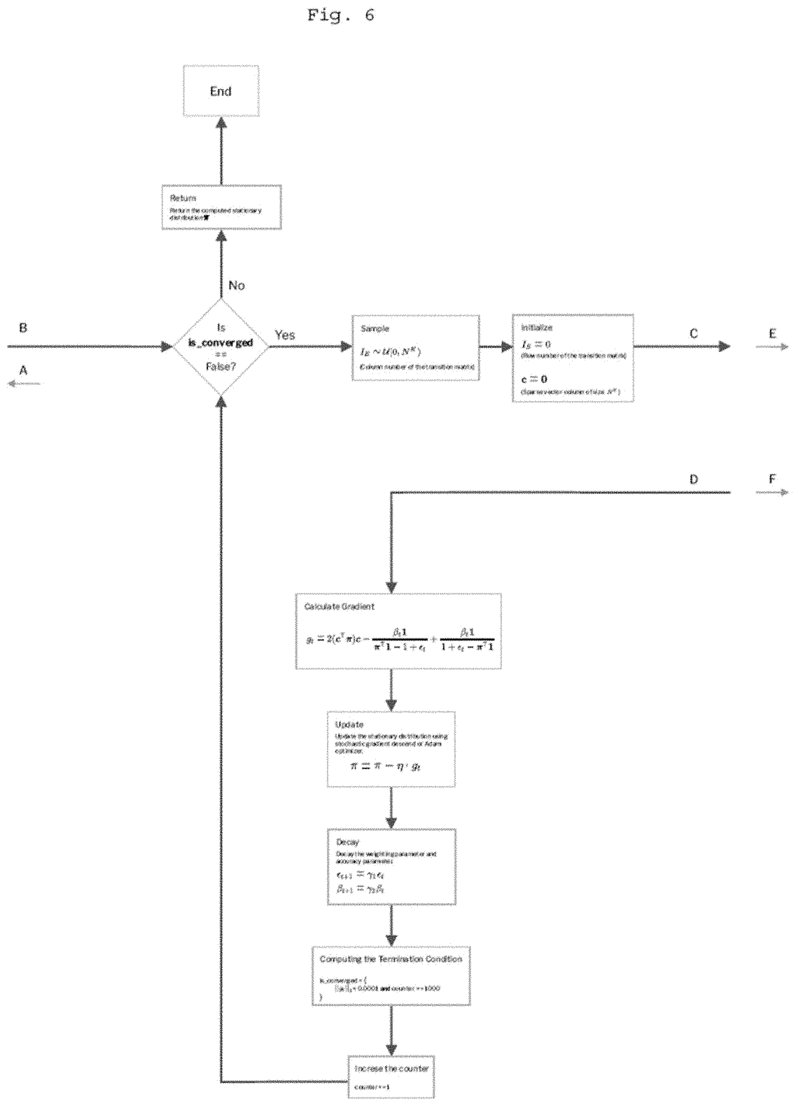

FIG. 5 shows the inputs to the system at 501. An initial value of it is set at 502. FIGS. 6 to 8 show the iterative steps performed as described above.

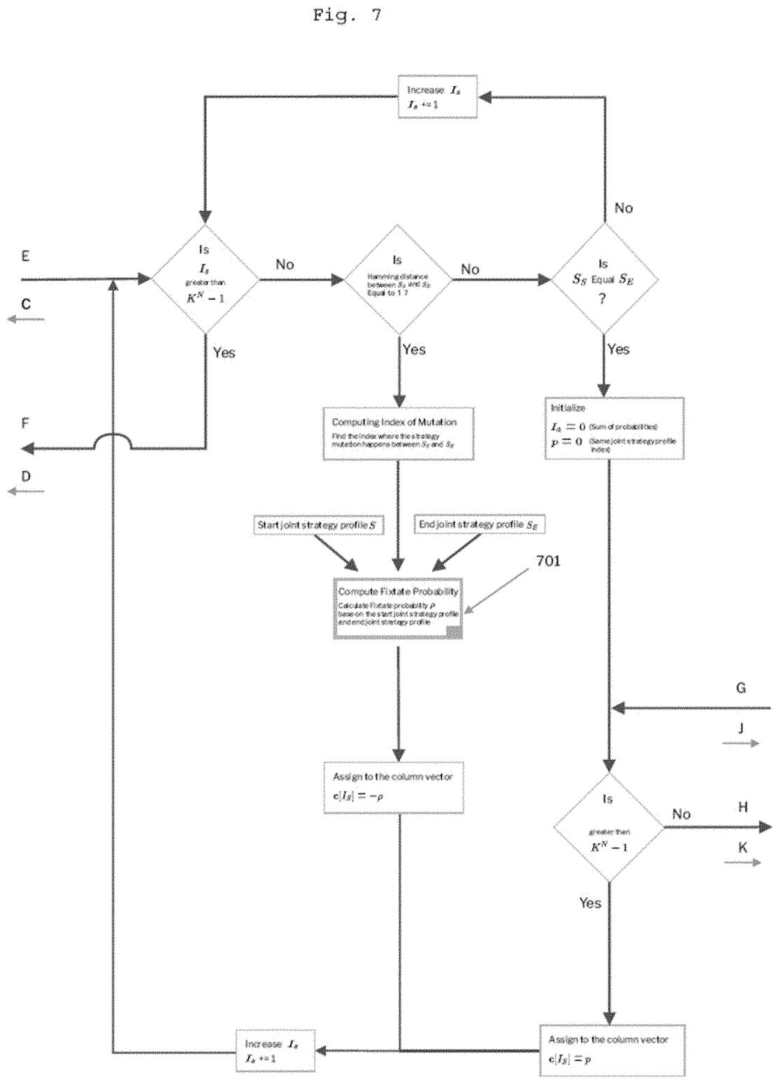

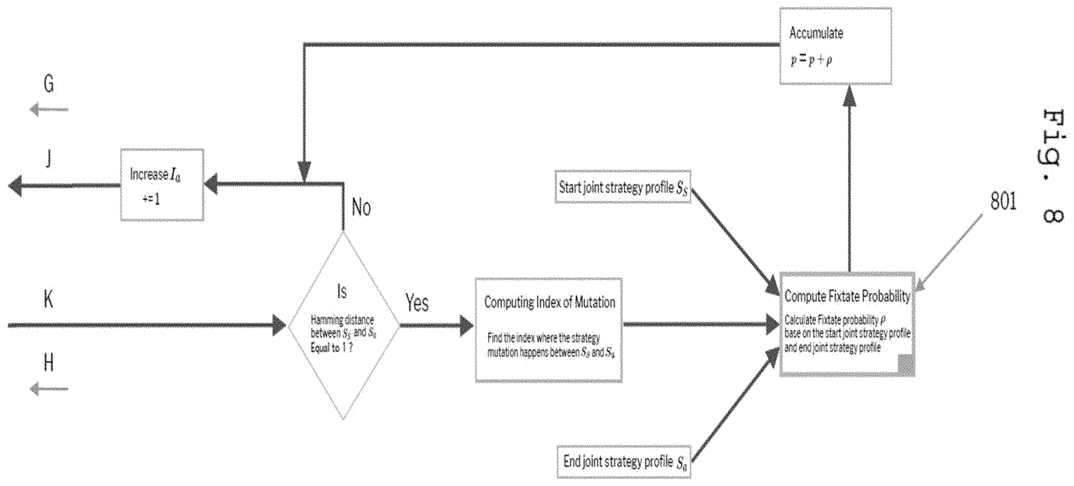

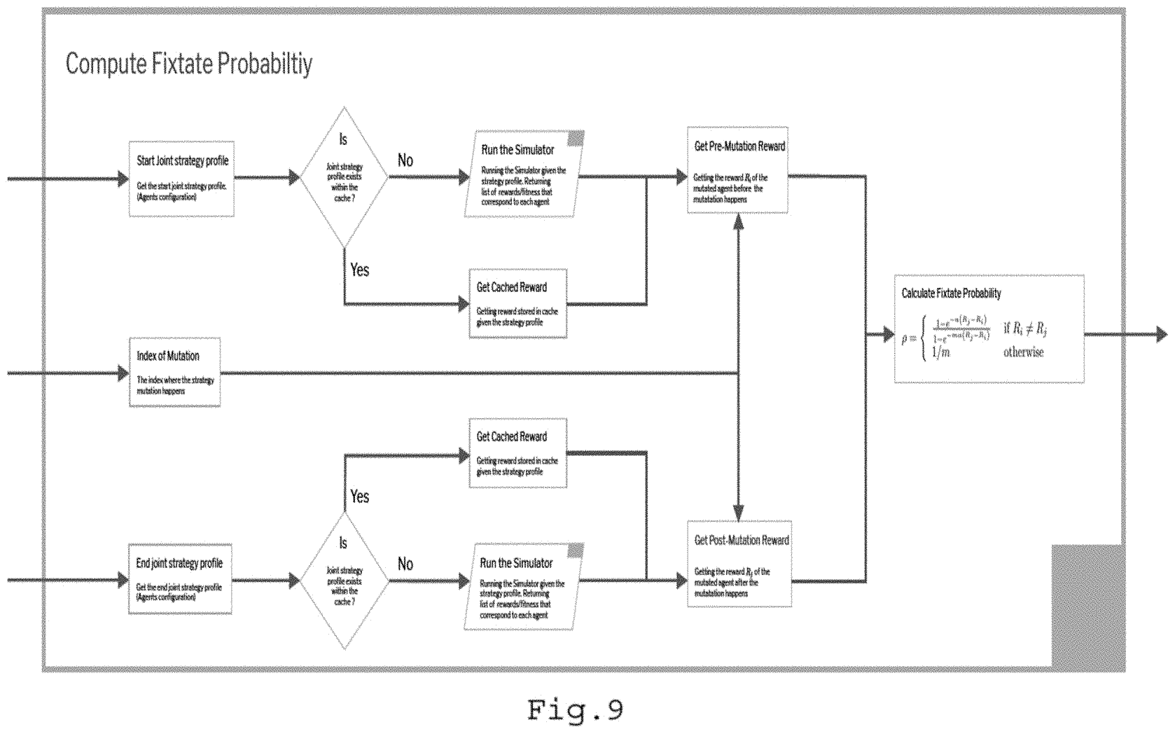

FIG. 9 shows a more detailed summary of the steps that are performed to compute the fixtate probability, indicated at 701 in FIGS. 7 and 801 in FIG. 8, based on the start joint strategy profiles and the end joint strategy profiles.

The general framework can deal with the policy evaluation problem for any multi-agent system. The method may therefore be deployed on any accessible multi-agent environment or an equivalent simulation engine that can take the agents' joint strategies as input and output each agent's fitness/reward value. With such an environment provided, by following the computation flow of the system diagram shown in FIGS. 5 to 8, the final ranking for all joint strategy profiles may be obtained as the output. Therefore, the algorithm (Algorithm 2, shown in FIG. 3) may compute the stationary distribution re, i.e. the ranking for the joint strategies, as illustrated generally in FIG. 1.

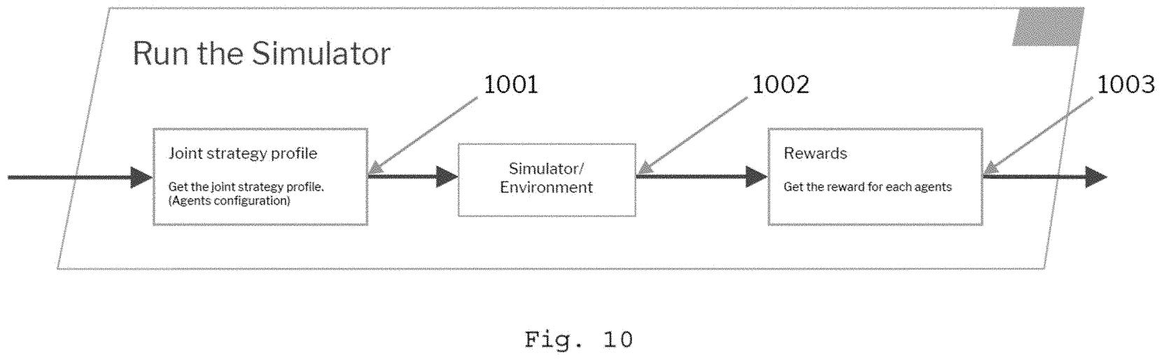

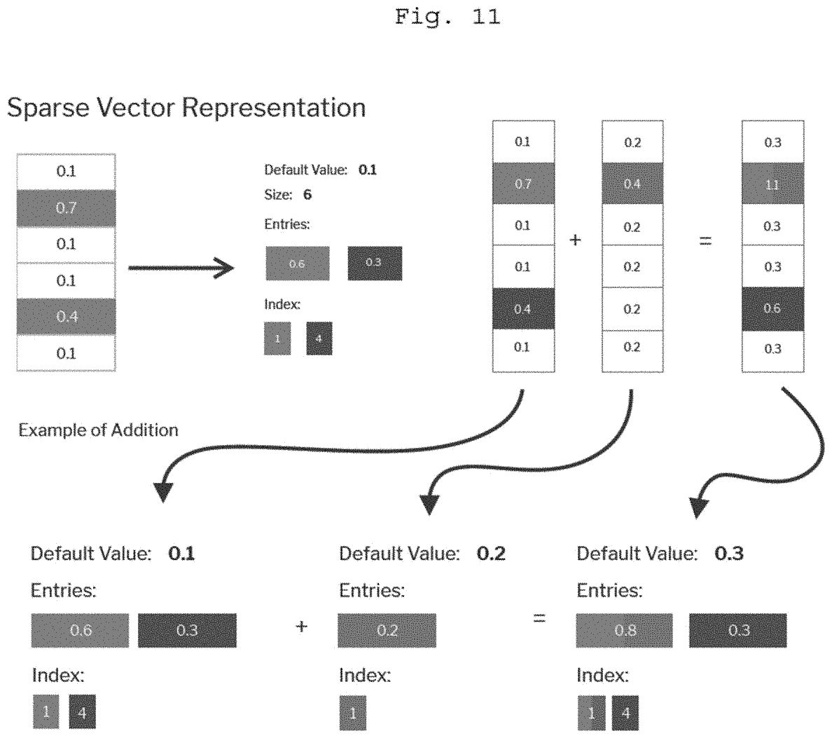

FIG. 10 summarises the steps that are performed generally when the simulator is run. At 1001, the joint strategy profiles are obtained from the agents. The methods described above are performed at 1002. At 1003, the rewards for each of the agents are obtained. The transitional probability matrix is commonly sparse, i.e. it contains many values which are the same. In the present invention, implementation of the algorithm also introduces a data structure for storing the sparse vector that fully leverages the sparse property of the transitional probability matrix C. This is illustrated in FIG. 11. In this data structure, the vector (i.e. a row or column of the matrix) is stored in a compressed form in which are specified: (i) the quantity of the most common value in the vector (in FIG. 11, this is 0.1) and (ii) the index and quantity of each of the values in the vector that is not equal to the most common value. The quantity of each of the values that is not equal to the most common value is specified as a difference between that quantity and the quantity of the most common value. For example, in FIG. 11, for values of 0.7 and 0.4, the differences are 0.6 and 0.3 respectively. Representing the sparse vector in this way may reduce memory consumption.

The policy evaluation method may therefore result in a significant amount of reduction in computation in both time and space in computing the stationary distribution π*, which is essentially the required ranking. In particular, the method described herein does not need to pre-compute and store the whole transition matrix, which could be prohibitively large. By adopting a stochastic optimization method with an augmented Lagrangian, only one column of the transition matrix is accessed at each iteration. The number of iterations needed are also much less than traditional linear algebra methods or power methods. This method is therefore directly applicable to policy evaluations for large-scale multi-agent systems.

As mentioned previously, in one example, the actors are self-driving cars and the policies are driving policies. In this example, M in Equation (2) indicates a representation of the fitness for a combination of joint driving policies. The cars are capable of interacting with each other in implementing the policies. In this way, the highest ranked combination of policies can result in relatively efficient and safe operation of the cars as a group.

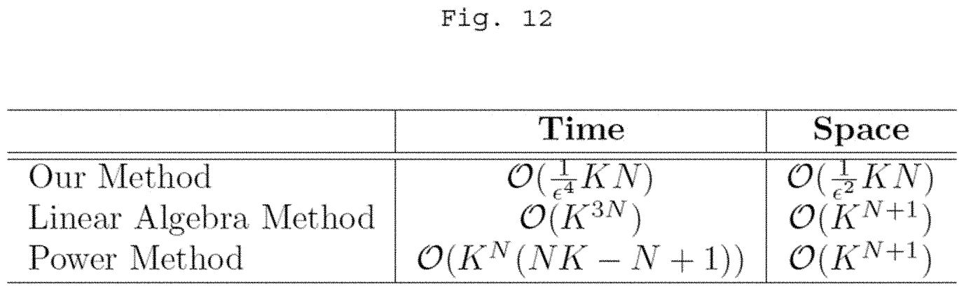

FIG. 12 shows a comparison of the Time and Space Complexity for the example of self-driving cars, where N=number of cars, K=number of strategies per car, [symbol] =precision.

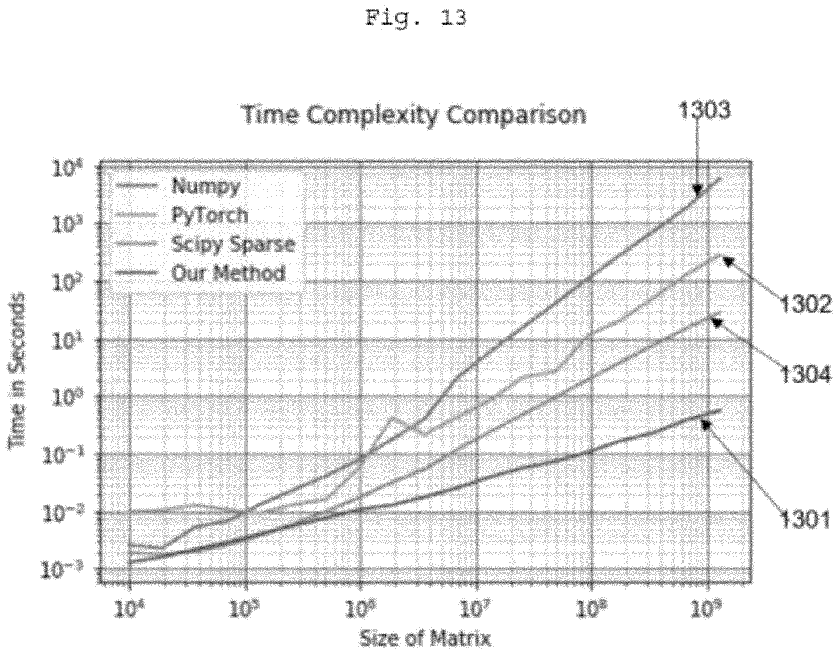

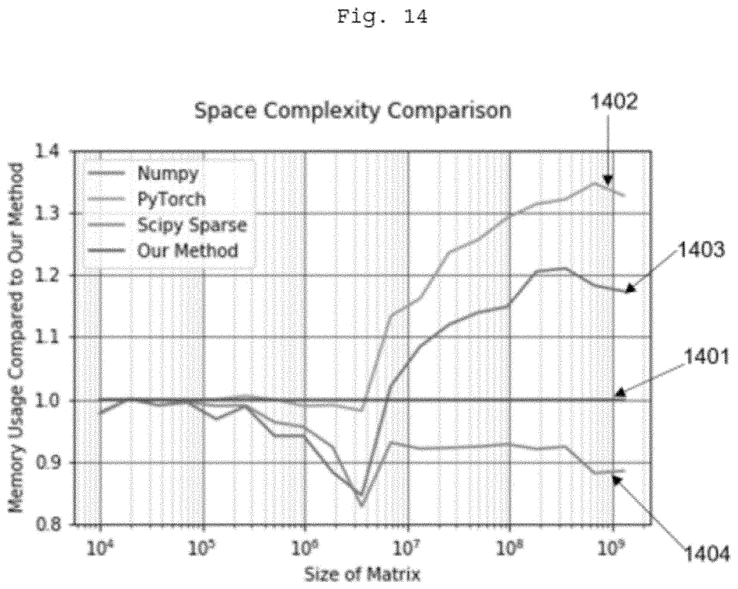

The results of comparative experiments are shown in FIGS. 13 and 14 for the time and space complexity of the present approach respectively.

FIG. 13 illustrates that the method described herein, shown by the line indicated at 1301, may achieve much faster (up to approximately 1000 times) speed compared to traditional linear algebra methods using the numerical libraries Python, shown at 1302, Numpy, shown at 1303, and Scipy, shown at 1304.

FIG. 14 illustrates that the method described herein, shown by the line indicated at 1401, may use significantly less memory compared to traditional linear algebra methods using the numerical libraries Python, shown at 1402, Numpy, shown at 1403, and Scipy, shown at 1404. There is less memory usage, as duplicated values are not saved.

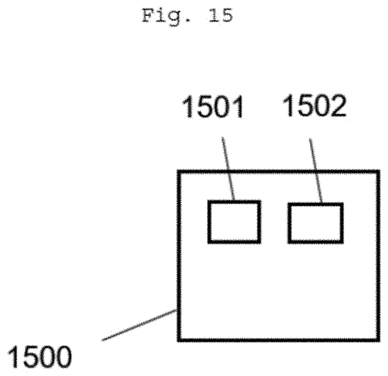

FIG. 15 shows a schematic diagram of a policy evaluation system 1500 configured to implement the methods described above and its associated components. The system may comprise a processor 1501 and a non-volatile memory 1502. The system may comprise more than one processor and more than one memory. The memory may store data that is executable by the processor. The processor may be configured to operate in accordance with a computer program stored in non-transitory form on a machine readable storage medium. The computer program may store instructions for causing the processor to perform its methods in the manner described herein.

In summary, described herein is an evolutionary dynamics methodology to evaluate agents' policies in large-scale multi-agent interactions. The method is able to model the inherently dynamical behaviours of the multi-agent policy evaluation problem, for example for a population of self-driving cars. Unlike traditional methods that suffer from conditionality problems when the total number of joint strategy profiles is large, the proposed algorithm can be scaled up to tackle large-scale multi-agent policy evaluation problems.

The method uses stochastic sampling on the transition matrix to fully leverage the sparsity of the ranking algorithm. Therefore, it can be applied to large-scale populations of agents and result in less computational time and more efficient memory usage. Implementations of the present invention may achieve 1000 times faster speed and significantly less memory consumption compared to traditional numerical libraries such as Python, Numpy & Scipy, and traditional methods such as power method in PageRank.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A computer-implemented policy evaluation system for identifying an optimal combination of operational policies for implementation by a plurality of actors, each actor being capable of adopting any of a plurality of operational policies, the policy evaluation system comprising:
a memory storing instructions; and
a processor communicatively coupled to the memory and configured to execute the instructions to configure the policy evaluation system to iteratively perform steps comprising:
(i) selecting a first combination of operational policies, the first combination of operational policies defining a policy for each actor of the plurality of actors;
(ii) receiving vectors of values, each representing a benefit of a respective second combination where all but one of the plurality of actors adopts the policy defined for it in the first combination of operational policies and that actor adopts a different policy; and
(iii) estimating a ranking of combinations of policies for the plurality of actors in dependence on the vectors of values and a previously estimated ranking of combinations of policies for the plurality of actors.

2. The policy evaluation system as claimed in claim 1, wherein the vectors of values is a row or column of a transition matrix of a joint-policy profile for all the actors.

3. The policy evaluation system as claimed in claim 1, wherein the iteratively performed steps further comprise:
(iv) assessing whether the ranking of combinations of policies for the plurality of actors has converged to a predetermined degree; and
(v) if that assessment is positive, assigning to each of the plurality of actors the policy defined for it in a highest-ranked combination in the ranking.

4. The policy evaluation system as claimed in claim 1, wherein the estimating the ranking of combinations of policies for the plurality of actors comprises estimating an adjustment from a previously estimated ranking of combinations of policies for the plurality of actors and applying that adjustment to the previously estimated ranking of combinations of policies for the plurality of actors.

5. The policy evaluation system as claimed in claim 1, wherein each value within the vectors of values are determined according to:
$$\{ \begin{matrix}\frac{1}{{\sum }_{k = 1}^{N} ( \vert {S}_{k} \vert - 1 )} {ρ}_{{s}_{i}^{k} , {s}_{j}^{k}}^{k} ( {s}_{i}^{- k} ) & if ∃ k \text{:} {s}_{i}^{k} \neq {s}_{j}^{k} \& {s}_{i}^{- k} = {s}_{j}^{- k} \\ 1 - {\sum }_{j \neq i} {c}_{ij} & if {s}_{i} = {s}_{j} \\ 0 & otherwise\end{matrix} \\ wherein \text{:} \\ {ρ}_{{s}_{i}^{k} , {s}_{j}^{k}}^{k} ( {s}_{i}^{- k} ) = \{ \begin{matrix}\frac{1 - {e}^{- α ( {M}^{( k )} ( {s}_{j}^{k} , {s}_{i}^{- k} ) - {M}^{( k )} ( {s}_{i}^{k} , {s}_{i}^{- k} ) )}}{1 - {e}^{- m α ( {M}^{( k )} ( {s}_{j}^{k} , {s}_{i}^{- k} ) - {M}^{( k )} ( {s}_{i}^{k} , {s}_{i}^{- k} ) )}} & if {M}^{( k )} ( {s}_{j}^{k} , {s}_{i}^{- k} ) \neq {M}^{( k )} ( {s}_{i}^{k} , {s}_{i}^{- k} ) \\ \frac{1}{m} & otherwise\end{matrix}$$
and:
α is a ranking intensity;
k is an index of the first agent;
M^{(k)}(sᵢ^{k},sᵢ^{-k}) is the fitness/reward for agent k using policy sᵢ^{k} while the other agents use policy sᵢ^{-k};
m is a hyper-parameter representing the population size; and
Sₖ is a k-th joint combination.

6. The policy evaluation system as claimed in claim 1, wherein the estimating the ranking of combinations of policies for the plurality of actors is performed according to:
$$Sample {i}_{t} ∼ [ 1 , … , n ] and {∇}_{x} {f}_{rel , i} = 2 ( {b}_{{i}_{t}}^{T} x ) {b}_{{i}_{t}} - \frac{{α}_{i} 1}{{x}_{i}^{r} 1 - 1 + {ϵ}_{1}} + \frac{{α}_{i} 1}{1 + {ϵ}_{t} - {x}_{i}^{r} 1} . \\ Update {x}_{t + 1} = {x}_{t} - {η}_{t} {∇}_{x} {f}_{rel , i} .$$
wherein:
b is the said vector of values;
l is a vector full of ones;
x is a rank to be output;
eta is a learning rate; and
epsilon is an accuracy parameter.

7. The policy evaluation system as claimed in claim 1, wherein the vectors of values are stored in a compressed form, the compressed form comprising: (i) a quantity of a most common value within the vectors of values and (ii) an index and quantity of each value within the vectors of values that is not equal to the most common value within the vectors of values.

8. The policy evaluation system as claimed in claim 7, wherein the quantity of each value within the vectors of values that is not equal to the most common value within the vectors of values is specified as a difference between that quantity and the quantity of the most common value within the vectors of values.

9. The policy evaluation system as claimed in claim 1, wherein in each iteration, only vectors of values in dependence on which a preferred combination of policies for the plurality of actors is estimated are the sets of values of the vectors of values each representing the benefit of the respective second combination where all but one of the actors adopts the policy defined for it in the first combination and that actor adopts the different policy.

10. The policy evaluation system as claimed in claim 2, wherein in each iteration only values within the vectors of values in dependence on which a preferred combination of policies for the plurality of actors is estimated is the values of the respective row or column of the transition matrix of the joint-policy profile for the plurality of actors.

11. The policy evaluation system as claimed in claim 5, wherein the plurality of actors are at least partially autonomous vehicles and the policies are driving policies.

12. The policy evaluation system as claimed in claim 11, wherein M indicates a representation of fitness for a combination of joint driving policies.

13. The policy evaluation system as claimed in claim 1, wherein the selecting the first combination of operational policies is performed stochastically.

14. A computer-implemented method for identifying an optimal combination of operational policies for implementation by a plurality of actors, each actor being capable of adopting any of a plurality of operational policies, the method comprising iteratively performing steps comprising:
(i) selecting a first combination of operational policies, the first combination of operational policies defining a policy for each actor of the plurality of actors;
(ii) receiving vectors of values, each representing a benefit of a respective second combination where all but one actor of the plurality of actors adopts a policy defined for it in the first combination of operational policies and that actor adopts a different policy; and
(iii) estimating a ranking of combinations of policies for the plurality of actors in dependence on the vectors of values and a previously estimated ranking of combinations of policies for the plurality of actors.

15. The method as claimed in claim 14, wherein the vectors of values is a row or column of a transition matrix of a joint-policy profile for all the actors.

16. The method as claimed in claim 14, wherein the iteratively performed steps further comprise:
(iv) assessing whether the ranking of combinations of policies for the plurality of actors has converged to a predetermined degree; and
(v) if that assessment is positive, assigning to each of the plurality of actors the policy defined for it in a highest-ranked combination in the ranking.

17. A non-transient computer readable medium storing instructions for identifying an optimal combination of operational policies for implementation by a plurality of actors, each actor being capable of adopting any of a plurality of operational policies, the instructions, when executed by a computer, configure the computer to iteratively perform steps comprising:
(i) selecting a first combination of operational policies, the first combination of operational policies defining a policy for each actor of the plurality of actors;
(ii) receiving vectors of values, each representing a benefit of a respective second combination where all but one of the actorsactor of the plurality of actors adopts the a policy defined for it in the first combination of operational policies and that actor adopts a different policy; and
(iii) estimating a ranking of combinations of policies for the plurality of actors in dependence on those vectors of values and a previously estimated ranking of combinations of policies for the plurality of actors.

18. The non-transitory computer readable medium as claimed in claim 17, wherein the vectors of values is a row or column of a transition matrix of a joint-policy profile for all the actors.

19. The non-transitory computer readable medium as claimed in claim 17, wherein the iteratively performed steps further comprise:
(iv) assessing whether the ranking of combinations of policies for the plurality of actors has converged to a predetermined degree; and
(v) if that assessment is positive, assigning to each of the plurality of actors the policy defined for it in a highest-ranked combination in the ranking.

20. The non-transitory computer readable medium as claimed in claim 17, wherein the estimating the ranking of combinations of policies for the plurality of actors comprises estimating an adjustment from a previously estimated ranking of combinations of policies for the plurality of actors and applying that adjustment to the previously estimated ranking of combinations of policies for the plurality of actors.
